(19) United States
(12) Patent Application Publication
(10) Pub. No.: US 2022/0121594 A1
(43) Pub. Date: Apr. 21, 2022

(54) SOC ARCHITECTURE TO REDUCE MEMORY BANDWIDTH BOTTLENECKS AND FACILITATE POWER MANAGEMENT

(71) Applicant: Intel Corporation, Santa Clara, CA (US)

(72) Inventors: Lakshminarayana Pappu, Folsom, CA (US); Ashwin A. Mendon, Hillsboro, OR (US); Nausheen Ansari, Folsom, CA (US); Howard L. Heck, Tigard, OR (US); David J. Harriman, Portland, OR (US)

(73) Assignee: Intel Corporation, Santa Clara, CA (US)

(21) Appl. No.: 17/561,144

(22) Filed: Dec. 23, 2021

(51) Int. Cl. G06F 13/40; G06F 13/16

(52) U.S. Cl. CPC G06F 13/4027; G06F 13/1668

(57) ABSTRACT

A system comprising a discrete graphics system-on-chip (SoC) to couple to a host processor unit, the SoC comprising a memory bridge comprising a first port to receive requests sent by a compute engine through a first path to the memory; and a second port to receive requests sent by a plurality of agents of the SoC through a second path to the memory.

### BACKGROUND

A computing system may comprise a discrete graphics system in which a graphics processing unit (GPU) is separate from a central processing unit (CPU). A system utilizing discrete graphics may comprise a memory used by the GPU that is different from a system memory used by the CPU. A system-on-chip (SoC) is an integrated circuit that combines different components, such as those traditionally associated with a processor-based system, into a single chip or, in some applications, within a small number of interconnected chips. In some systems, a GPU may be implemented by a SoC.

### BRIEF DESCRIPTION OF THE DRAWINGS

FIG. 1 illustrates a system comprising an alternative memory path to graphics memory in accordance with certain embodiments.

FIG. 2 illustrates circuitry of the graphics SoC of FIG. 1 in accordance with certain embodiments.

FIG. 3 illustrates a memory port in accordance with certain embodiments.

FIG. 4 illustrates additional circuitry of the graphics SoC of FIG. 1 in accordance with certain embodiments.

FIG. 5 illustrates a bridge endpoint in accordance with certain embodiments.

FIG. 6 illustrates a memory bridge in accordance with certain embodiments.

FIG. 7 illustrates an example computer system in accordance with certain embodiments.

FIG. 8 illustrates a block diagram of components present in a computing system in accordance with various embodiments.

FIG. 9 illustrates a block diagram of another computing system in accordance with various embodiments.

Like reference numbers and designations in the various drawings indicate like elements.

### DETAILED DESCRIPTION

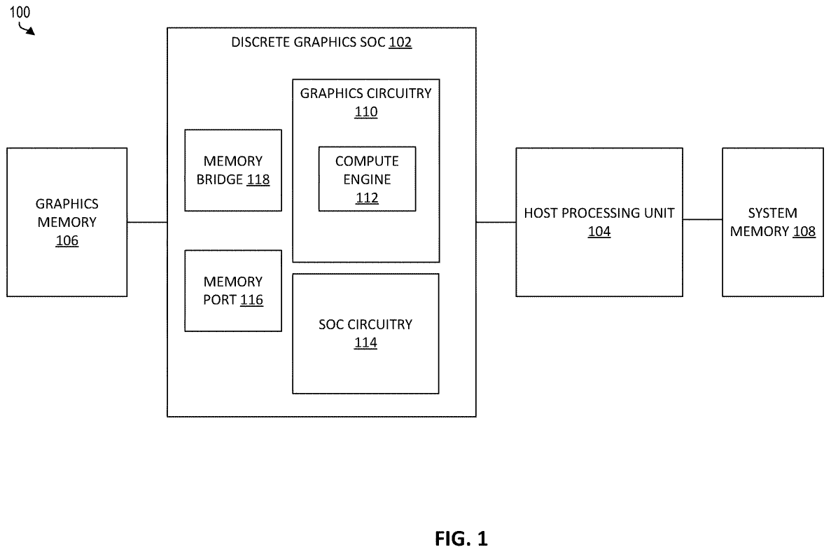

FIG. 1 illustrates a system 100 comprising an alternative memory path to graphics memory 106 in accordance with certain embodiments. System 100 includes a discrete graphics system on chip (SoC) 102 coupled to a host processing unit 104 (e.g., a central processing unit or other suitable processor) and a graphics memory 106. The SoC 102 may implement a graphics processing unit (GPU) that is separate from (e.g., on a different chip and/or package) the host processing unit 104. Host processing unit 104 is also coupled to system memory 108. SoC 102 includes graphics circuitry 110, including a compute engine 112, (which may also be referred to as a graphics engine or a rendering engine), system-on-chip (SoC) circuitry 114, memory port 116, and memory bridge 118. In various embodiments, the discrete graphics SoC 102 may comprise a single semiconductor chip or multiple semiconductor chips, e.g., in a common package (e.g., the graphics circuitry 110 may be implemented by a first chip, the SoC circuitry may be implemented by a second chip, and the memory bridge 118 and memory port 116 may be placed on either chip, a third chip, or split between multiple chips).

A discrete graphics SoC (e.g., 102) may provide deep power state support, such as the modern standby standard. The power states supported may be relatively aggressive. However, sometimes one or more components of an SoC may fail to enter the prescribed low power state. Root causing the issue may be difficult when the sole path to the graphics memory 106 goes through the compute engine 112 (indeed it can take architects months to root cause these issues in some cases). Moreover, various agents of the SoC (e.g., circuitry within the SoC circuitry 114) may send traffic to the graphics memory 106 through the compute engine 112, but routing such traffic through the compute engine 112 may introduce congestion issues for other traffic flowing through the high bandwidth compute engine 112 (which may, e.g., function as a rendering agent).

In various embodiments of the present disclosure, an alternative memory interconnect path to the graphics memory 106 is provided for various agents of the SoC 102 and/or for traffic from a host (e.g., host processing unit 104). The alternative memory interconnect path may include the memory port 116 and the memory bridge 118 which will be described in more detail below. This alternative memory interconnect path may be used to root-cause issues associated with failure to enter low power states. Low power agents may access the alternative interconnect to perform debugging/root-causing of the low power system platform without causing all or a portion of graphics circuitry 110 (e.g., compute engine 112) to wake up (which could frustrate the purpose of finding the root cause). During debugging, the alternative memory interconnect path may be used to check functionality of the graphics memory 106. Furthermore, the compute engine 112 may go into a low power state frequently and power savings may be achieved by providing the alternative memory interconnect path so that the compute engine 112 does not have to be woken up each time an agent of the SoC needs to communicate with the graphics memory 106.

This alternative memory interconnect path may include an efficient fabric and router to provide a path for the SoC agents to send traffic to the graphics memory 106. In some embodiments, the alternative memory interconnect path may have a lower bandwidth than the path to the graphics memory 106 through the compute engine 112. In various embodiments, this alternative memory interconnect path may be active when the SoC 102 is placed into one or more low power states in which the compute engine 112 is powered down, thus higher-power consuming circuitry blocks that are in deeper power states do not need to be awakened to enable communication with the graphics memory 106. The alternative memory interconnect path may include arbitration logic to arbitrate among traffic destined for the graphics memory 106 that is received from various sources (e.g., render traffic, display traffic, etc.), e.g., so that high priority traffic is given priority. In one example, memory bridge 118 may implement a weighted arbitration mechanism between various agents that send traffic to the graphics memory 106 without hindering the main traffic.

In some examples, the alternative memory interconnect path may be power gated during normal operation and then enabled when the SoC 102 enters a lower power state to be used for low power platform debug. In other examples, the alternative memory interconnect path may remain on during normal operation and during low power operation. In yet other examples, the alternative memory interconnect path may be power gated when no traffic is sent on the path and woken up when traffic arrives.

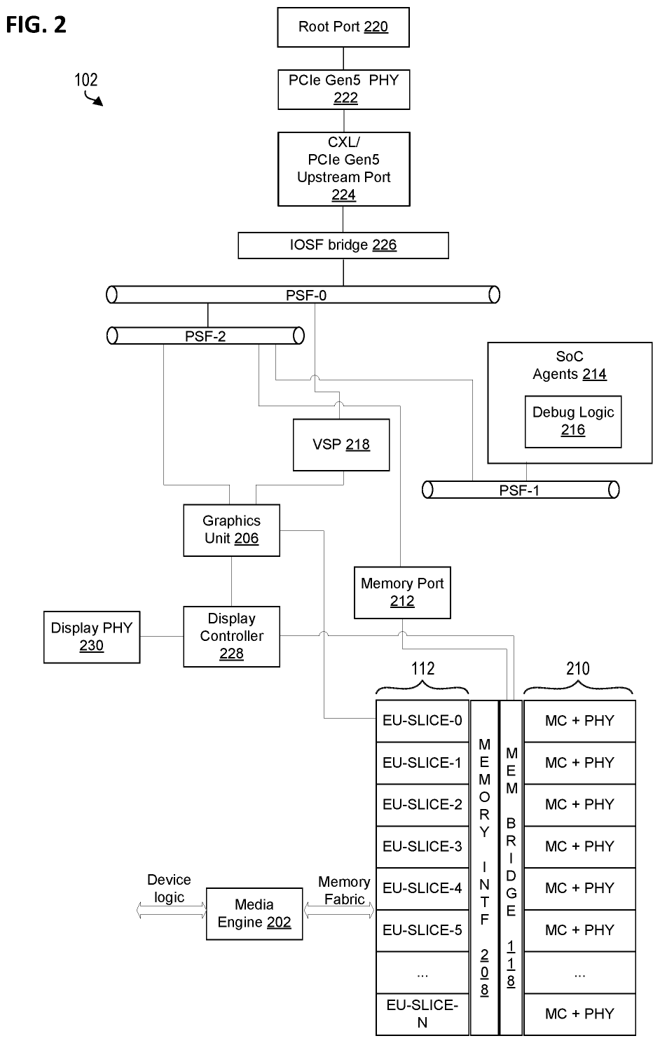

FIG. 2 illustrates circuitry of the SoC 102 of FIG. 1 in accordance with certain embodiments. The circuitry includes a media engine 202 coupled to a compute engine 112. The media engine 202 may comprise scalable media blocks and global controls. Media engine 202 may perform any suitable operations on video data, such as encoding/decoding, encrypting/decrypting, or other suitable processing operations on the video data. Media engine 202 may communicate with the graphics memory 106 through the compute engine 112 (and thus through the memory interface 208 and memory bridge 118).

Compute engine 112 may comprise a plurality of modular execution unit (EU) slices (e.g., EU-slice-0 to EU-slice-N) to process data. Compute engine 112 may perform any suitable compute operations, such as rendering operations (e.g., shading, lighting, texturing, etc.). Compute engine 112 may be coupled to the graphics unit 206. The graphics unit 206 may be responsible for interfacing the compute engine 112 with the host. For example, the graphics unit 206 may sequence transactions between the host and the compute engine 112 and may ensure message ordering (e.g., PCIe ordering). Such host transactions may include, e.g., configuration transactions, memory transactions, or I/O transactions. The EU-slices are each coupled through a memory interface 208 to memory bridge 118. The main memory path may pass through the compute engine 112 and the memory interface 208.

The memory bridge 118 also couples, via an alternative memory interconnect path, various other circuitry of the SoC 102 (or a host coupled to the SoC 102, e.g., via root port 220) to the memory subsystem 210 (which itself is coupled to the graphics memory 106). This alternative memory interconnect path may include memory port 212 and interconnect fabric (e.g., primary scalable fabric (PSF)-2, PSF-0, and/or PSF-1). Circuitry coupled to the graphics memory 106 via the alternative memory interconnect path may include, e.g., SoC agents 214 (including debug logic 216 among other circuitry).

SoC agents 214 may include any suitable circuitry to support the operations of the SoC 102. Various examples of SoC agents that may use the graphics memory 106 include debug logic 216 (e.g., that may collect debug data from the SoC and transfer it to the graphics memory 106), a serial peripheral interface (SPI) controller, a flash device controller, a Type-C (e.g., USB4) port (e.g., for a virtual reality (VR) or other subsystem to offload audio and/or video content), an audio controller, a security engine (e.g., that may require paging support and authenticates various firmware blocks), or other suitable circuitry.

In some embodiments, the SoC 102 may include a debug engine. For example, the debug engine may be part of debug logic 216. The debug engine configures (e.g., enables) SoC components to transmit data in a secured mode. Enabled components may transmit internal signal (e.g., from respective finite state machines) and register information during this mode. The components may also send intermediate machine and protocol states. The debug engine may receive the data and process the data (e.g., by compressing and/or packetizing it). The debug engine then transmits the data over the alternative memory path to graphics memory 106. After the debug data collection is completed, a debug mode may be entered into. During this mode, the debug engine may read the data from the graphics memory 106 and transmit the data to an outside entity (e.g., the data may be transmitted over general purpose input/output (GPIO) pins to decoding logic outside the SoC 102). This decoding logic may decompress the data, analyze the data, and display the data (e.g., in waveforms). The displayed data may be used to identify anomalies in machine operation that could be the cause of bugs in the functioning of the circuits of the SoC 102.

Although, the SoC agents 214 are shown as being coupled to the memory port 212 through PSF-1 and PSF-2, the SoC agents 214 may be coupled to the memory port 212 through any suitable combination of suitable interconnect fabrics (e.g., through PSF-0 and PSF-2, through PSF-2, through one or more other types of interconnect fabric). In some embodiments, particular SoC agents may couple to the memory port 212 via one or more interconnect fabrics while other SoC agents may couple to the memory port 212 via one or more other interconnect fabrics.

An interconnect fabric (e.g., PSF-0 through PSF-2 or other suitable fabric) may utilize any suitable communication protocol to communicate packets. One implementation may utilize an integrated on-chip system fabric (IOSF) specification to provide a standardized on-die interconnect protocol for attaching circuitry of varying types within the SoC 102. In some embodiments, a PSF may comprise a highly configurable SoC backbone based on the IOSF standard. PSFs are used to create an IOSF-compliant hierarchy that provides interconnection of circuitry blocks within an SoC or within an I/O subsystem.

The interconnect fabric of the alternative graphics memory path may comprise routing tables. Whereas a traditional path from an SoC agent 214 to the graphics memory 106 may pass through graphics unit 206 and compute engine 112, the routing tables of the interconnect fabric shown in FIG. 2 direct the traffic from the SoC agents 214 through memory port 212 instead. Thus, routing tables in PSF-1 and PSF-2 may direct such traffic towards memory port 212. One of the interconnect fabrics (e.g., PSF-2 in the embodiment depicted) may isolate the alternate graphics memory interconnect path from the main graphics memory path which runs from PSF-0 to virtual switch port (VSP) 218 to graphics unit 206 to compute engine 112. In some embodiments, the interconnect fabric of the alternative graphics memory interconnect path supports bandwidth up to 16 GB/sec, although other embodiments may support other bandwidths.

In some embodiments, a host (e.g., host processing unit 104) may also be able to access the alternative graphics memory path, e.g., through a path comprising root port 220, PCIe Gen5 PHY 222, CXL/PCIe Gen5 upstream port 224, IOSF bridge 226, PSF-0, PSF-2, and memory port 212 (or other suitable path comprising any suitable communication components or interconnect fabric).

In the embodiment depicted, a second alternative graphics memory interconnect path is provided for the display controller 228. In the embodiment depicted, the display controller 228 is coupled directly to the memory bridge 118 (although in other embodiments, other communication elements may be present in the path from the display controller 228 to the memory bridge 118). In general, the display controller 228 may consume graphics memory bandwidth at a relatively high rate (e.g., at a higher rate than any of the SoC agents 214), as the display controller 228 may provide the image data to be displayed by one or more displays (e.g., monitors) to one or more display PHYs 230.

The memory bridge 118 arbitrates between memory requests coming from SoC components (e.g., SoC agents 214 and display controller 228) and memory requests from compute engine 112. The memory bridge 118 may communicate requests to memory subsystem 210, which communicates the requests to the graphics memory 106 to cause the requests to be carried out. Memory subsystem 210 comprises a plurality of memory controllers (MC) and PHYs coupled to the graphics memory 106, where a particular memory controller and PHY may be coupled to respective memory device of the graphics memory 106.

The graphics memory 106 may comprise any suitable type of memory, such as dual data rate (DDR) memory such as low-power DDR (LPDDR) or graphics DDR (GDDR) (or other suitable memory, including any type of memory described herein). In some embodiments, the graphics memory 106 is permanently or removably coupled to the SoC 102.

Although various FIGs. herein may illustrate components that are compatible with particular protocols or fabrics (e.g., PCIe Gen5, IOSF, PSF, etc.), the embodiments of the present disclosure contemplate components using any other suitable communication protocols or fabrics. Thus, a particular component that is labeled with a particular protocol or fabric may be understood to be a broader disclosure of that type of component (e.g., an IOSF bridge 226 may in other embodiments be any suitable type of communication bridge).

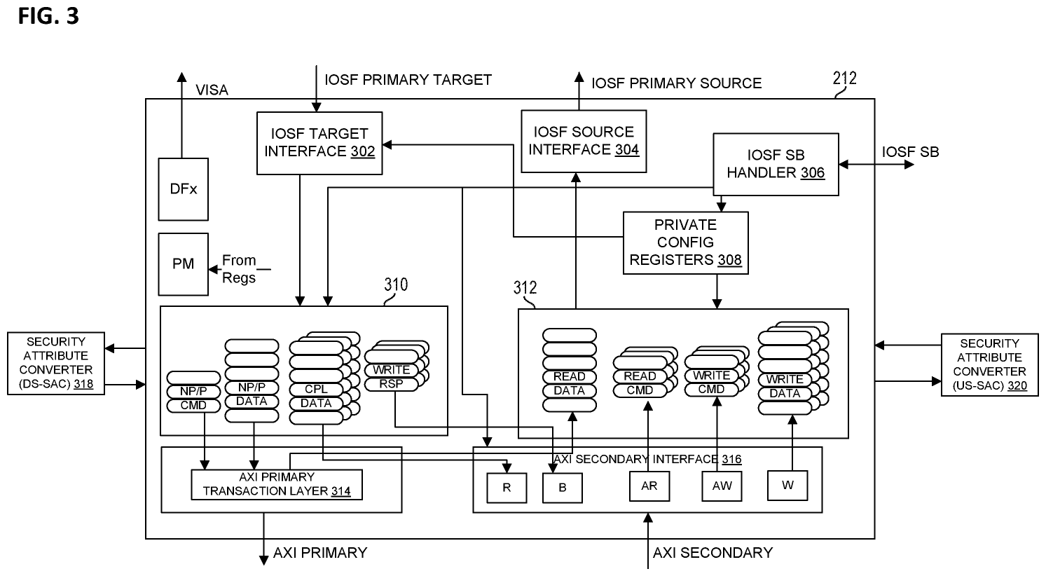

FIG. 3 illustrates a memory port 212 in accordance with certain embodiments. The memory port 212 facilitates routing of the traffic from the components of the SoC 102 to the memory bridge 118. In various embodiments, the memory port 212 may translate a protocol of the incoming SoC traffic (e.g., IOSF in the embodiment depicted) to a format of the bridge (e.g., advanced eXtensible interface (AXI) in the embodiment depicted).

Memory port 212 may include an interface 302 to receive incoming communications, a corresponding interface 304 for outgoing communications, and a sideband (SB) handler 306 for sideband communications. Memory port 212 also includes private configuration registers 308, which may be used to configure any suitable component of the memory port 212. In some embodiments, the IOSF SB handler 306 may be used to program the configuration registers 308.

Memory port 212 also includes queues 310 (which may include, e.g., queues for non-posted/posted commands, non-posted/posted data, completion data, and write responses) and queues 312 (which may include, e.g., queues for read data, read commands, write commands, and write data). The queue used for a particular transaction may be based on the transaction type (e.g., posted transaction, non-posted transaction, completion, etc.).

The queues may be coupled to the AXI primary transaction layer 314 and AXI secondary interface 316 as shown. The AXI secondary interface 316 may include various channels including a read data channel (R), a write response channel (B), a read address channel (AR), a write address channel (AW), and a write data channel (W).

The memory port 212 may also implement security features for received communications by utilizing downstream and upstream security attribute converters 318 and 320. For example, the memory port 212 may filter out transactions based on security attributes and return zero completion or unsupported request messages if the security attributes are not correct or pass the transactions on to the memory bridge 118 if the security check passes.

The memory port 212 may also include an internal hardware signal-level trace (e.g., Visualization of Internal Signal Architecture (VISA)) which collects functional signals. The signals may be communicated via a debug port interface (e.g., a Design for Debug, Test, Manufacturing, and/or Validation (DFx) interface). Thus debug information may be communicated to and/or from the memory port 212.

In various embodiments, the memory port 212 may maintain PCIe ordering of traffic going to and received from the memory bridge 118. In one embodiment, the memory port 212 operates at a bandwidth of 6.4 GB/sec, although in other embodiments, the memory port 212 operates at any suitable bandwidth.

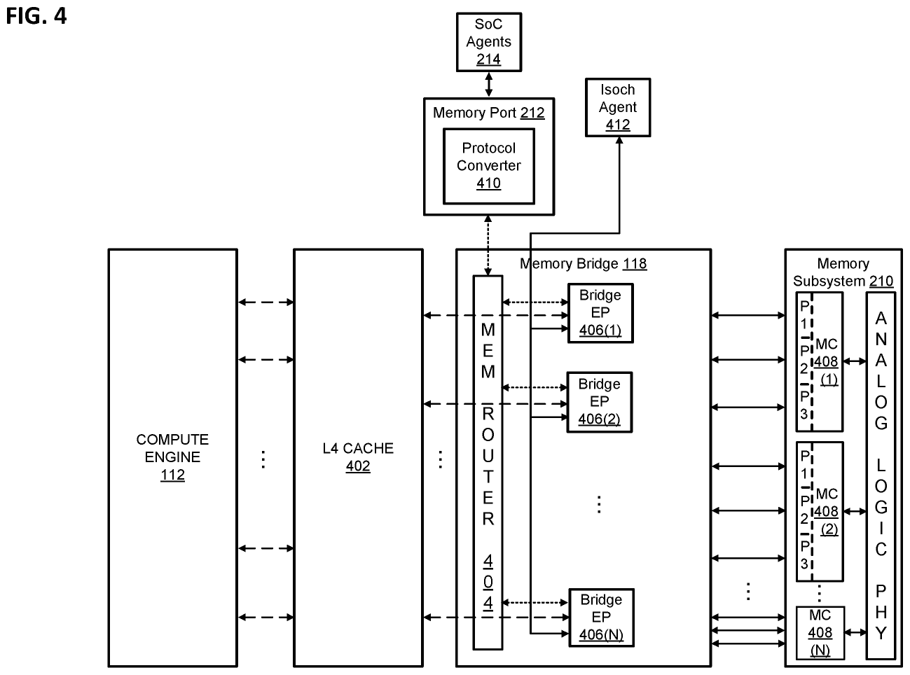

FIG. 4 illustrates additional circuitry (including a memory bridge 118) of the SoC 102 of in accordance with certain embodiments. In this embodiment, a cache (e.g., L4 cache 402) sits between the compute engine 112 and the memory bridge 118 (such that contents of the graphics memory 106 requested by the compute engine 112 are cached by the L4 cache 402). A cache controller of the L4 cache 402 may manage which requests by the compute engine 112 are serviced by the L4 cache and which requests are passed on to the memory bridge 118.

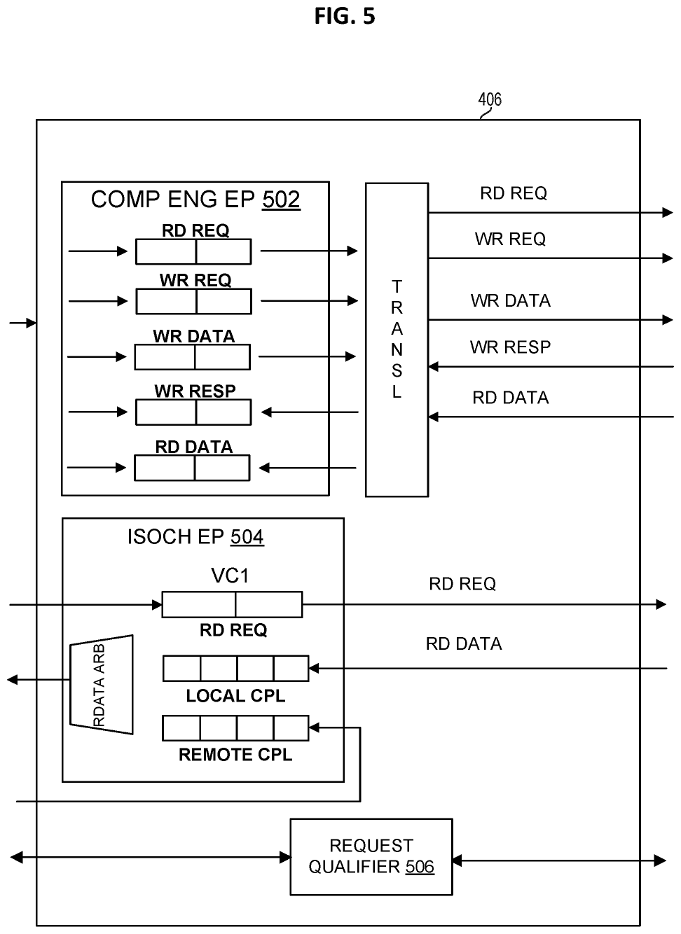

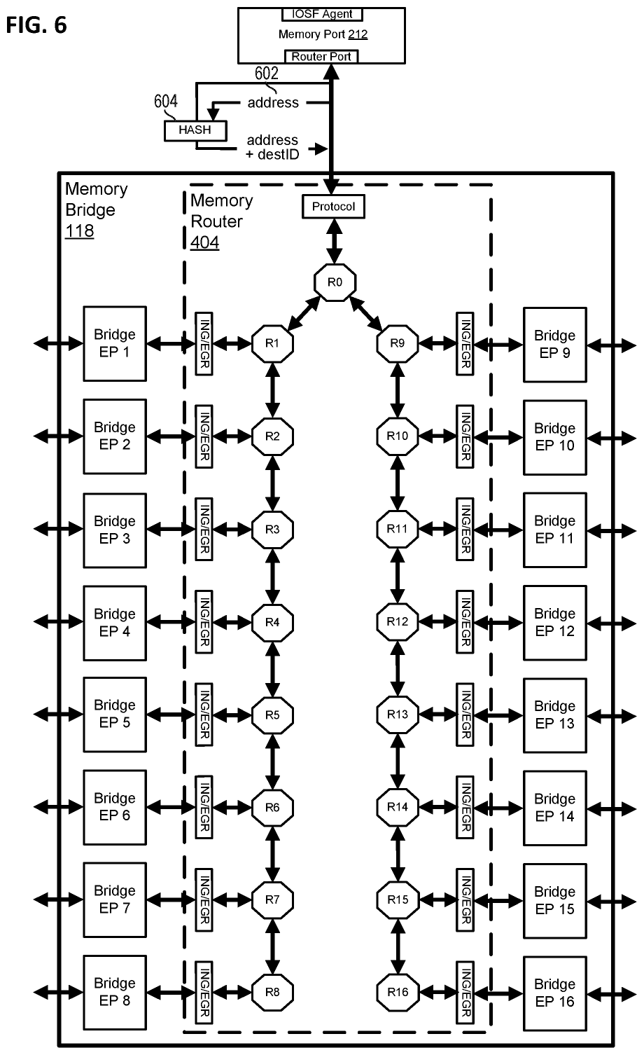

Memory bridge 118 includes memory router 404 (described in more detail in connection with FIG. 6)) and a plurality of bridge endpoints 406 (e.g., 406(1), 406(2), . . . 406(N). The memory router 404 may route communications between the SoC agents 214 and the memory subsystem 210 and may include any suitable queues (not shown) to enable communication between the SoC agents 214 and the memory subsystem (e.g., for read requests, write requests, read data, write data, write responses, etc.). In various embodiments, communications between the memory subsystem 210 and the isochronous agent 412 or compute engine 112 do not pass through the memory router 404, but rather pass through respective compute engine or isochronous endpoints within the bridge endpoints 406 (to be depicted later). Each bridge endpoint 406 may couple to a corresponding memory controller 408 (e.g., 408(1), 408(2), . . . 408(N)) of the memory subsystem 210. Incoming requests from any of the memory paths may be routed to a bridge endpoint 406 (and subsequently a corresponding memory controller 408) based on a memory address of a request (e.g., the memory address may be hashed to select the bridge endpoint 406). The bridge endpoints 406 are shown in more detail in FIG. 5.

In the embodiment depicted, memory bridge 118 may receive memory requests from the compute engine 112 (e.g., via the L4 cache), from SoC agents 214 (e.g., via memory port 212), and from an isochronous agent 412. The isochronous agent 412 may be an agent that has bursty traffic and/or quality of service (QOS) requirements. In one embodiment, the isochronous agent 412 may comprise the display controller 228. In some embodiments, the memory port 212 may include a protocol converter 410 (not explicitly shown in FIG. 3) to convert one or more protocols used by the SoC agents 214 to a protocol used by the memory bridge 118.

The memory bridge 118 may be capable of arbitrating multiple (e.g., three in the embodiment depicted) high bandwidth traffic patterns to the memory devices of the graphics memory 106. Any suitable arbitration logic may be used to arbitrate between the traffic associated with the compute engine 112, the SoC agents 214, and the isochronous agent 412. In one example, priority may be given to traffic from the isochronous agent 412 and/or the compute engine 112 over the traffic from the SoC agents 214. The arbitration logic may also fairly arbitrate between competing requests by multiple SoC agents 214 and/or fairly arbitrate between competing requests by the compute engine 112. In some embodiments, the arbitration logic may use a weighted arbitration scheme to favor requests from one or more SoC agents over other SoC agents (or to performed weighted arbitration of two or more of requests from the compute engine 112, requests from the SoC agents 214, and requests from the isochronous agent 412).

The memory bridge 118 may also manage completions. When a completion comes back from the memory subsystem 210, the memory bridge 118 may also route the completion back to the appropriate channel (e.g., through the memory port 212 towards an SoC agent 214, to the isochronous agent 412, or to the compute engine 112).

In some embodiments, the memory bridge 118 may also split large incoming requests into smaller size requests (e.g., 64 bytes) compatible with the format used by the memory subsystem 210. When a completion is received, the memory bridge 118 may combine data from multiple messages into a larger message before sending back towards the appropriate recipient.

FIG. 5 illustrates a bridge endpoint 406 in accordance with certain embodiments. A bridge endpoint 406 may be responsible for receiving incoming transactions and negotiating credits with source and destination agents. Each endpoint 406 may provide three dedicated channels between transaction agents and the memory subsystem 210. On the transaction agent side, the endpoint 406 presents three ingress ports, one to interface with the compute engine 112, one to interface with the isochronous agent 412, and one to interface with the set of SoC agents 214. On the memory subsystem 210 side, a bridge endpoint provides three memory fabric ports to interface with three ingress ports of the corresponding memory controller 408.

A bridge endpoint 406 may convert incoming protocols to a common format used to communicate with the memory subsystem 210. For example, requests received from the compute engine 112 may be received in a first protocol format, requests received from the SoC agents 214 via the memory port 212 may be received in a second protocol format, and requests received from the isochronous agent 412 may be received in a third protocol format. In one embodiment, the requests sent by the bridge endpoint 406 to the memory subsystem 210 may be formatted according to the same protocol as the requests received from the SoC agents via the memory port 212.

Bridge endpoint 406 may comprise a compute engine endpoint 502 that receives requests from the compute engine 112, an isochronous agent endpoint 504 that receives requests from the isochronous agent 412, a request qualifier 506 (e.g., that receives requests from SoC agents via the memory port 212 and memory router 404 and verifies whether a request is valid for a particular memory controller 408 before passing on the request to the particular memory controller 408), and translation logic 508. The compute engine endpoint 502 may include queues for read requests, write requests, write data, write responses, and read data. Isochronous endpoint 504 may include queues for read requests, local completions, and remote completions.

FIG. 6 illustrates a memory bridge 118 including a memory router 404 in accordance with certain embodiments. The memory router 404 is responsible for routing the received traffic from the SoC agents 214 from the memory port to the appropriate bridge endpoint 406 to be passed onto the appropriate memory controller.

As depicted, a memory address 602 of a transaction may be hashed by hash logic 604 to generate a destination ID (destID) which is passed along with the memory address in a transaction sent to the memory router 404. The memory router 404 then routes the transaction to the appropriate bridge endpoint 406 based on the destID.

The memory router 404 may have one ingress port and one egress port per incoming agent. In some embodiments, the SoC 102 may include some memory controllers 408 proximate one side of the SoC and other memory controllers 408 proximate the other side of the SoC. Accordingly, the routers may also be placed on opposite sides of the SoC (e.g., in two columns as depicted). Other suitable physical arrangements are contemplated herein.

In some embodiments, the router 404 may be configured to use multiple virtual channels (VCs). In one embodiment, the data width of the router is 16B, but in other embodiments other suitable widths may be used. In various embodiment, each routing element (e.g., R0-R16) may maintain a communication credit system with a bridge endpoint.

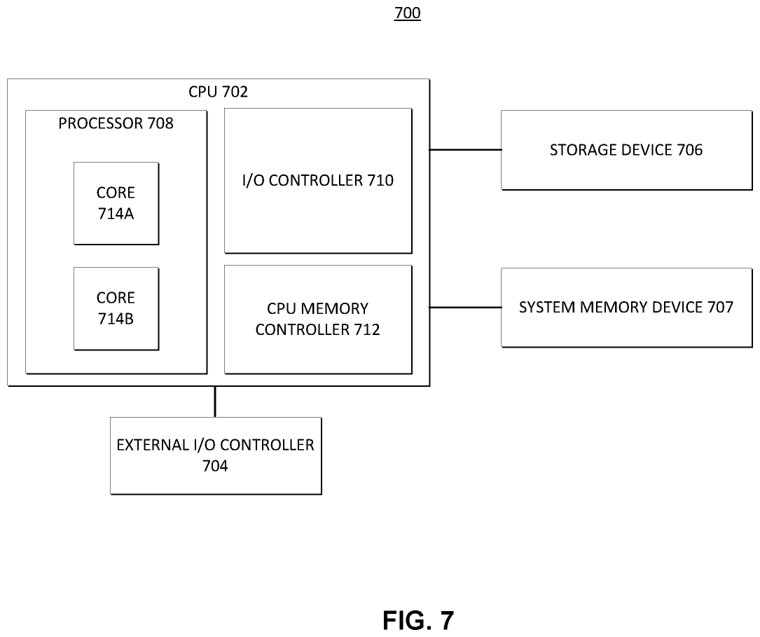

FIGS. 7-9 depict example systems in which various embodiments described herein may be implemented. For example, any of the systems depicted (or one or more components thereof) may be included within system 100. For example, CPU 702 or processor 810 may represent a host processing unit that may be coupled to SoC 102 and system memory device 707 may represent an example of system memory 108 (or graphics memory 106). As another example, GPU 915 and/or video codec 920 could be included within SoC 102.

FIG. 7 illustrates components of a computer system 700 in accordance with certain embodiments. System 700 includes a central processing unit (CPU) 702 coupled to an external input/output (I/O) controller 704, a storage device 706 such as a solid state drive (SSD) or a dual inline memory module (DIMM), and system memory device 707. During operation, data may be transferred between a storage device 706 and/or system memory device 707 and the CPU 702. In various embodiments, particular memory access operations (e.g., read and write operations) involving a storage device 706 or system memory device 707 may be issued by an operating system and/or other software applications executed by processor 708.

CPU 702 comprises a processor 708, such as a microprocessor, an embedded processor, a digital signal processor (DSP), a network processor, a handheld processor, an application processor, a co-processor, an SOC, or other device to execute code (e.g., software instructions). Processor 708, in the depicted embodiment, includes two processing elements (cores 714A and 714B in the depicted embodiment), which may include asymmetric processing elements or symmetric processing elements. However, a processor may include any number of processing elements that may be symmetric or asymmetric. CPU 702 may be referred to herein as a host computing device (though a host computing device may be any suitable computing device operable to issue memory access commands to a storage device 706).

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core 714 (e.g., 714A or 714B) may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

In various embodiments, the processing elements may also include one or more arithmetic logic units (ALUs), floating point units (FPUs), caches, instruction pipelines, interrupt handling hardware, registers, or other hardware to facilitate the operations of the processing elements.

In some embodiments, processor 708 may comprise a processor unit, such as a processor core, graphics processing unit, hardware accelerator, field programmable gate array, neural network processing unit, artificial intelligence processing unit, inference engine, data processing unit, or infrastructure processing unit.

I/O controller 710 is an integrated I/O controller that includes logic for communicating data between CPU 702 and I/O devices. In other embodiments, the I/O controller 710 may be on a different chip from the CPU 702. I/O devices may refer to any suitable devices capable of transferring data to and/or receiving data from an electronic system, such as CPU 702. For example, an I/O device may comprise an audio/video (A/V) device controller such as a graphics accelerator or audio controller; a data storage device controller, such as a flash memory device, magnetic storage disk, or optical storage disk controller; a wireless transceiver; a network processor; a network interface controller; or a controller for another input device such as a monitor, printer, mouse, keyboard, or scanner; or other suitable device. In a particular embodiment, an I/O device may comprise a storage device 706 coupled to the CPU 702 through I/O controller 710.

An I/O device may communicate with the I/O controller 710 of the CPU 702 using any suitable signaling protocol, such as peripheral component interconnect (PCI), PCI Express (PCIe), Universal Serial Bus (USB), Serial Attached SCSI (SAS), Serial ATA (SATA), Fibre Channel (FC), IEEE 802.3, IEEE 802.11, or other current or future signaling protocol. In particular embodiments, I/O controller 710 and an associated I/O device may communicate data and commands in accordance with a logical device interface specification such as Non-Volatile Memory Express (NVMe) (e.g., as described by one or more of the specifications available at www.nvmexpress.org/specifications/) or Advanced Host Controller Interface (AHCI) (e.g., as described by one or more AHCI specifications such as Serial ATA AHCI: Specification, Rev. 1.3.1 available at http://www.intel.com/content/www/us/en/io/serial-ata/serial-ata-ahci-spec-rev1-3-1.html). In various embodiments, I/O devices coupled to the I/O controller 710 may be located off-chip (e.g., not on the same chip as CPU 702) or may be integrated on the same chip as the CPU 702.

CPU memory controller 712 is an integrated memory controller that controls the flow of data going to and from one or more system memory devices 707. CPU memory controller 712 may include logic operable to read from a system memory device 707, write to a system memory device 707, or to request other operations from a system memory device 707. In various embodiments, CPU memory controller 712 may receive write requests from cores 714 and/or I/O controller 710 and may provide data specified in these requests to a system memory device 707 for storage therein. CPU memory controller 712 may also read data from a system memory device 707 and provide the read data to I/O controller 710 or a core 714. During operation, CPU memory controller 712 may issue commands including one or more addresses of the system memory device 707 in order to read data from or write data to memory (or to perform other operations). In some embodiments, CPU memory controller 712 may be implemented on the same chip as CPU 702, whereas in other embodiments, CPU memory controller 712 may be implemented on a different chip than that of CPU 702. I/O controller 710 may perform similar operations with respect to one or more storage devices 706.

The CPU 702 may also be coupled to one or more other I/O devices through external I/O controller 704. In a particular embodiment, external I/O controller 704 may couple a storage device 706 to the CPU 702. External I/O controller 704 may include logic to manage the flow of data between one or more CPUs 702 and I/O devices. In particular embodiments, external I/O controller 704 is located on a motherboard along with the CPU 702. The external I/O controller 704 may exchange information with components of CPU 702 using point-to-point or other interfaces.

A system memory device 707 may store any suitable data, such as data used by processor 708 to provide the functionality of computer system 700. For example, data associated with programs that are executed or files accessed by cores 714 may be stored in system memory device 707. Thus, a system memory device 707 may include a system memory that stores data and/or sequences of instructions that are executed or otherwise used by the cores 714. In various embodiments, a system memory device 707 may store temporary data, persistent data (e.g., a user's files or instruction sequences) that maintains its state even after power to the system memory device 707 is removed, or a combination thereof. A system memory device 707 may be dedicated to a particular CPU 702 or shared with other devices (e.g., one or more other processors or other devices) of computer system 700.

In various embodiments, a system memory device 707 may include a memory comprising any number of memory partitions, a memory device controller, and other supporting logic (not shown). A memory partition may include non-volatile memory and/or volatile memory.

Non-volatile memory is a storage medium that does not require power to maintain the state of data stored by the medium, thus non-volatile memory may have a determinate state even if power is interrupted to the device housing the memory. Nonlimiting examples of nonvolatile memory may include any or a combination of: 3D crosspoint memory, phase change memory (e.g., memory that uses a chalcogenide glass phase change material in the memory cells), ferroelectric memory, silicon-oxide-nitride-oxide-silicon (SONOS) memory, polymer memory (e.g., ferroelectric polymer memory), ferroelectric transistor random access memory (Fe-TRAM) ovonic memory, anti-ferroelectric memory, nanowire memory, electrically erasable programmable read-only memory (EEPROM), a memristor, single or multi-level phase change memory (PCM), Spin Hall Effect Magnetic RAM (SHE-MRAM), and Spin Transfer Torque Magnetic RAM (STTRAM), a resistive memory, magnetoresistive random access memory (MRAM) memory that incorporates memristor technology, resistive memory including the metal oxide base, the oxygen vacancy base and the conductive bridge Random Access Memory (CB-RAM), a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory.

Volatile memory is a storage medium that requires power to maintain the state of data stored by the medium (thus volatile memory is memory whose state (and therefore the data stored on it) is indeterminate if power is interrupted to the device housing the memory). Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (double data rate version 3, original release by JEDEC (Joint Electronic Device Engineering Council) on Jun. 27, 2007, currently on release 21), DDR4 (DDR version 4, JESD79-4 initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5, originally published by JEDEC in January 2020, HBM2 (HBM version 2), originally published by JEDEC in January 2020, or others or combinations of memory technologies, and technologies based on derivatives or extensions of such specifications.

A storage device 706 may store any suitable data, such as data used by processor 708 to provide functionality of computer system 700. For example, data associated with programs that are executed or files accessed by cores 714A and 714B may be stored in storage device 706. Thus, in some embodiments, a storage device 706 may store data and/or sequences of instructions that are executed or otherwise used by the cores 714A and 714B. In various embodiments, a storage device 706 may store persistent data (e.g., a user's files or software application code) that maintains its state even after power to the storage device 706 is removed. A storage device 706 may be dedicated to CPU 702 or shared with other devices (e.g., another CPU or other device) of computer system 700.

In various embodiments, storage device 706 may comprise a disk drive (e.g., a solid state drive); a memory card; a Universal Serial Bus (USB) drive; a Dual In-line Memory Module (DINIM), such as a Non-Volatile DIMM (NVDIMM); storage integrated within a device such as a smartphone, camera, or media player; or other suitable mass storage device.

In a particular embodiment, a semiconductor chip may be embodied in a semiconductor package. In various embodiments, a semiconductor package may comprise a casing comprising one or more semiconductor chips (also referred to as dies). A package may also comprise contact pins or leads used to connect to external circuits.

In some embodiments, all or some of the elements of system 700 are resident on (or coupled to) the same circuit board (e.g., a motherboard). In various embodiments, any suitable partitioning between the elements may exist. For example, the elements depicted in CPU 702 may be located on a single die (e.g., on-chip) or package or any of the elements of CPU 702 may be located off-chip or off-package. Similarly, the elements depicted in storage device 706 may be located on a single chip or on multiple chips. In various embodiments, a storage device 706 and a computing host (e.g., CPU 702) may be located on the same circuit board or on the same device and in other embodiments the storage device 706 and the computing host may be located on different circuit boards or devices.

The components of system 700 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, and a Gunning transceiver logic (GTL) bus. In various embodiments, an integrated I/O subsystem includes point-to-point multiplexing logic between various components of system 700, such as cores 714, one or more CPU memory controllers 712, I/O controller 710, integrated I/O devices, direct memory access (DMA) logic (not shown), etc. In various embodiments, components of computer system 700 may be coupled together through one or more networks comprising any number of intervening network nodes, such as routers, switches, or other computing devices. For example, a computing host (e.g., CPU 702) and the storage device 706 may be communicably coupled through a network.

Although not depicted, system 700 may use a battery and/or power supply outlet connector and associated system to receive power, a display to output data provided by CPU 702, or a network interface allowing the CPU 702 to communicate over a network. In various embodiments, the battery, power supply outlet connector, display, and/or network interface may be communicatively coupled to CPU 702. Other sources of power can be used such as renewable energy (e.g., solar power or motion based power).

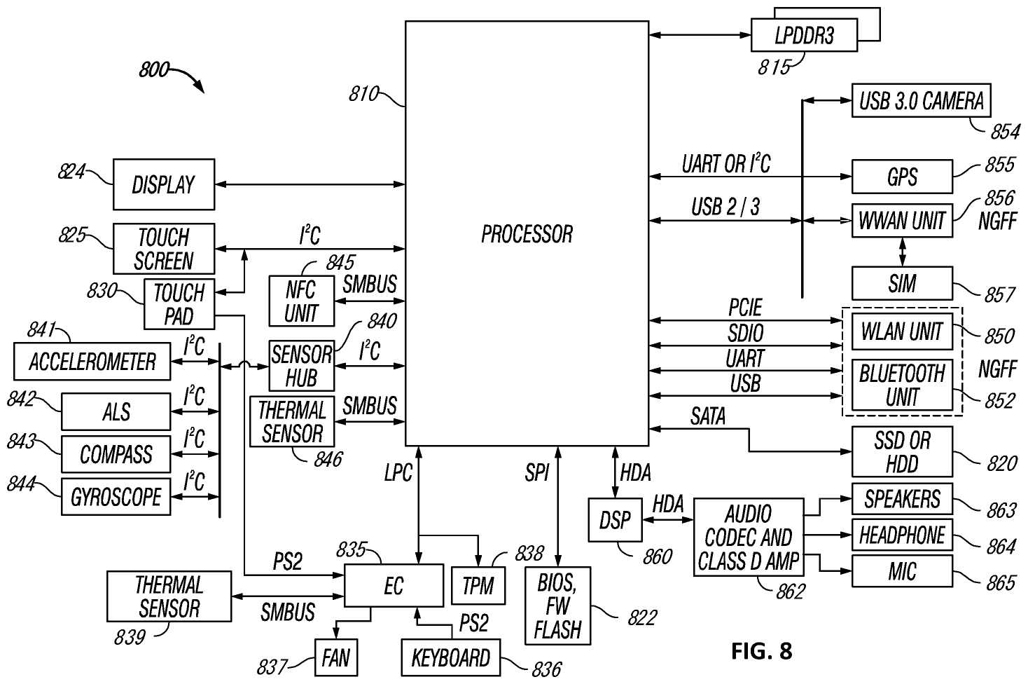

Referring now to FIG. 8, a block diagram of components present in a computer system that may function as either a host device or a peripheral device (or which may include both a host device and one or more peripheral devices) in accordance with certain embodiments is described. As shown in FIG. 8, system 800 includes any combination of components. These components may be implemented as ICs, portions thereof, discrete electronic devices, or other modules, logic, hardware, software, firmware, or a combination thereof adapted in a computer system, or as components otherwise incorporated within a chassis of the computer system. Note also that the block diagram of FIG. 8 is intended to show a high level view of many components of the computer system. However, it is to be understood that some of the components shown may be omitted, additional components may be present, and different arrangement of the components shown may occur in other implementations. As a result, the disclosure described above may be implemented in any portion of one or more of the interconnects illustrated or described below.

As seen in FIG. 8, a processor 810, in one embodiment, includes a microprocessor, multi-core processor, multithreaded processor, an ultra-low voltage processor, an embedded processor, or other known processing element. In the illustrated implementation, processor 810 acts as a main processing unit and central hub for communication with many of the various components of the system 800. As one example, processor 810 is implemented as a system on a chip (SoC). As a specific illustrative example, processor 810 includes an Intel® Architecture Core™-based processor such as an i3, i5, i7 or another such processor available from Intel Corporation, Santa Clara, Calif. However, other low power processors such as those available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note that many of the customer versions of such processors are modified and varied; however, they may support or recognize a specific instructions set that performs defined algorithms as set forth by the processor licensor. Here, the microarchitecture implementation may vary, but the architectural function of the processor is usually consistent. Certain details regarding the architecture and operation of processor 810 in one implementation will be discussed further below to provide an illustrative example.

Processor 810, in one embodiment, communicates with a system memory 815. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (QDP). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage 820 may also couple to processor 810. In various embodiments, to enable a thinner and lighter system design as well as to improve system responsiveness, this mass storage may be implemented via a SSD. However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also shown in FIG. 8, a flash device 822 may be coupled to processor 810, e.g., via a serial peripheral interface (SPI). This flash device may provide for non-volatile storage of system software, including a basic input/output software (BIOS) as well as other firmware of the system.

In various embodiments, mass storage of the system is implemented by a SSD alone or as a disk, optical or other drive with an SSD cache. In some embodiments, the mass storage is implemented as a SSD or as a HDD along with a restore (RST) cache module. In various implementations, the HDD provides for storage of between 320 GB-4 terabytes (TB) and upward while the RST cache is implemented with a SSD having a capacity of 24 GB-256 GB. Note that such SSD cache may be configured as a single level cache (SLC) or multi-level cache (MLC) option to provide an appropriate level of responsiveness. In a SSD-only option, the module may be accommodated in various locations such as in a mSATA or NGFF slot. As an example, an SSD has a capacity ranging from 120 GB-1 TB.

Various input/output (10) devices may be present within system 800. Specifically shown in the embodiment of FIG. 8 is a display 824 which may be a high definition LCD or LED panel configured within a lid portion of the chassis. This display panel may also provide for a touch screen 825, e.g., adapted externally over the display panel such that via a user's interaction with this touch screen, user inputs can be provided to the system to enable desired operations, e.g., with regard to the display of information, accessing of information and so forth. In one embodiment, display 824 may be coupled to processor 810 via a display interconnect that can be implemented as a high performance graphics interconnect. Touch screen 825 may be coupled to processor 810 via another interconnect, which in an embodiment can be an I2C interconnect. As further shown in FIG. 8, in addition to touch screen 825, user input by way of touch can also occur via a touch pad 830 which may be configured within the chassis and may also be coupled to the same I2C interconnect as touch screen 825.

The display panel may operate in multiple modes. In a first mode, the display panel can be arranged in a transparent state in which the display panel is transparent to visible light. In various embodiments, the majority of the display panel may be a display except for a bezel around the periphery. When the system is operated in a notebook mode and the display panel is operated in a transparent state, a user may view information that is presented on the display panel while also being able to view objects behind the display. In addition, information displayed on the display panel may be viewed by a user positioned behind the display. Or the operating state of the display panel can be an opaque state in which visible light does not transmit through the display panel.

In a tablet mode the system is folded shut such that the back display surface of the display panel comes to rest in a position such that it faces outwardly towards a user, when the bottom surface of the base panel is rested on a surface or held by the user. In the tablet mode of operation, the back display surface performs the role of a display and user interface, as this surface may have touch screen functionality and may perform other known functions of a conventional touch screen device, such as a tablet device. To this end, the display panel may include a transparency-adjusting layer that is disposed between a touch screen layer and a front display surface. In some embodiments the transparency-adjusting layer may be an electrochromic layer (EC), a LCD layer, or a combination of EC and LCD layers.

In various embodiments, the display can be of different sizes, e.g., an 11.6″ or a 13.3″ screen, and may have a 16:9 aspect ratio, and at least 300 nits brightness. Also the display may be of full high definition (HD) resolution (at least 1920×1080 p), be compatible with an embedded display port (eDP), and be a low power panel with panel self refresh.

As to touch screen capabilities, the system may provide for a display multi-touch panel that is multi-touch capacitive and being at least 5 finger capable. And in some embodiments, the display may be 10 finger capable. In one embodiment, the touch screen is accommodated within a damage and scratch-resistant glass and coating (e.g., Gorilla Glass™ or Gorilla Glass 2TM) for low friction to reduce “finger burn” and avoid “finger skipping”. To provide for an enhanced touch experience and responsiveness, the touch panel, in some implementations, has multi-touch functionality, such as less than 2 frames (30 Hz) per static view during pinch zoom, and single-touch functionality of less than 1 cm per frame (30 Hz) with 200 ms (lag on finger to pointer). The display, in some implementations, supports edge-to-edge glass with a minimal screen bezel that is also flush with the panel surface, and limited IO interference when using multi-touch.

For perceptual computing and other purposes, various sensors may be present within the system and may be coupled to processor 810 in different manners. Certain inertial and environmental sensors may couple to processor 810 through a sensor hub 840, e.g., via an I2C interconnect. In the embodiment shown in FIG. 8, these sensors may include an accelerometer 841, an ambient light sensor (ALS) 842, a compass 843 and a gyroscope 844. Other environmental sensors may include one or more thermal sensors 846 which in some embodiments couple to processor 810 via a system management bus (SMBus) bus.

Using the various inertial and environmental sensors present in a platform, many different use cases may be realized. These use cases enable advanced computing operations including perceptual computing and also allow for enhancements with regard to power management/battery life, security, and system responsiveness.

For example, with regard to power management/battery life issues, based at least on part on information from an ambient light sensor, the ambient light conditions in a location of the platform are determined and intensity of the display controlled accordingly. Thus, power consumed in operating the display is reduced in certain light conditions.

As to security operations, based on context information obtained from the sensors such as location information, it may be determined whether a user is allowed to access certain secure documents. For example, a user may be permitted to access such documents at a work place or a home location. However, the user is prevented from accessing such documents when the platform is present at a public location. This determination, in one embodiment, is based on location information, e.g., determined via a GPS sensor or camera recognition of landmarks. Other security operations may include providing for pairing of devices within a close range of each other, e.g., a portable platform as described herein and a user's desktop computer, mobile telephone or so forth. Certain sharing, in some implementations, are realized via near field communication when these devices are so paired. However, when the devices exceed a certain range, such sharing may be disabled. Furthermore, when pairing a platform as described herein and a smartphone, an alarm may be configured to be triggered when the devices move more than a predetermined distance from each other, when in a public location. In contrast, when these paired devices are in a safe location, e.g., a work place or home location, the devices may exceed this predetermined limit without triggering such alarm.

Responsiveness may also be enhanced using the sensor information. For example, even when a platform is in a low power state, the sensors may still be enabled to run at a relatively low frequency. Accordingly, any changes in a location of the platform, e.g., as determined by inertial sensors, GPS sensor, or so forth is determined. If no such changes have been registered, a faster connection to a previous wireless hub such as a Wi-Fi™ access point or similar wireless enabler occurs, as there is no need to scan for available wireless network resources in this case. Thus, a greater level of responsiveness when waking from a low power state is achieved.

It is to be understood that many other use cases may be enabled using sensor information obtained via the integrated sensors within a platform as described herein, and the above examples are only for purposes of illustration. Using a system as described herein, a perceptual computing system may allow for the addition of alternative input modalities, including gesture recognition, and enable the system to sense user operations and intent.

In some embodiments one or more infrared or other heat sensing elements, or any other element for sensing the presence or movement of a user may be present. Such sensing elements may include multiple different elements working together, working in sequence, or both. For example, sensing elements include elements that provide initial sensing, such as light or sound projection, followed by sensing for gesture detection by, for example, an ultrasonic time of flight camera or a patterned light camera.

Also in some embodiments, the system includes a light generator to produce an illuminated line. In some embodiments, this line provides a visual cue regarding a virtual boundary, namely an imaginary or virtual location in space, where action of the user to pass or break through the virtual boundary or plane is interpreted as an intent to engage with the computing system. In some embodiments, the illuminated line may change colors as the computing system transitions into different states with regard to the user. The illuminated line may be used to provide a visual cue for the user of a virtual boundary in space, and may be used by the system to determine transitions in state of the computer with regard to the user, including determining when the user wishes to engage with the computer.

In some embodiments, the computer senses user position and operates to interpret the movement of a hand of the user through the virtual boundary as a gesture indicating an intention of the user to engage with the computer. In some embodiments, upon the user passing through the virtual line or plane the light generated by the light generator may change, thereby providing visual feedback to the user that the user has entered an area for providing gestures to provide input to the computer.

Display screens may provide visual indications of transitions of state of the computing system with regard to a user. In some embodiments, a first screen is provided in a first state in which the presence of a user is sensed by the system, such as through use of one or more of the sensing elements.

In some implementations, the system acts to sense user identity, such as by facial recognition. Here, transition to a second screen may be provided in a second state, in which the computing system has recognized the user identity, where this second the screen provides visual feedback to the user that the user has transitioned into a new state. Transition to a third screen may occur in a third state in which the user has confirmed recognition of the user.

In some embodiments, the computing system may use a transition mechanism to determine a location of a virtual boundary for a user, where the location of the virtual boundary may vary with user and context. The computing system may generate a light, such as an illuminated line, to indicate the virtual boundary for engaging with the system. In some embodiments, the computing system may be in a waiting state, and the light may be produced in a first color. The computing system may detect whether the user has reached past the virtual boundary, such as by sensing the presence and movement of the user using sensing elements.

In some embodiments, if the user has been detected as having crossed the virtual boundary (such as the hands of the user being closer to the computing system than the virtual boundary line), the computing system may transition to a state for receiving gesture inputs from the user, where a mechanism to indicate the transition may include the light indicating the virtual boundary changing to a second color.

In some embodiments, the computing system may then determine whether gesture movement is detected. If gesture movement is detected, the computing system may proceed with a gesture recognition process, which may include the use of data from a gesture data library, which may reside in memory in the computing device or may be otherwise accessed by the computing device.

If a gesture of the user is recognized, the computing system may perform a function in response to the input, and return to receive additional gestures if the user is within the virtual boundary. In some embodiments, if the gesture is not recognized, the computing system may transition into an error state, where a mechanism to indicate the error state may include the light indicating the virtual boundary changing to a third color, with the system returning to receive additional gestures if the user is within the virtual boundary for engaging with the computing system.

As mentioned above, in other embodiments the system can be configured as a convertible tablet system that can be used in at least two different modes, a tablet mode and a notebook mode. The convertible system may have two panels, namely a display panel and a base panel such that in the tablet mode the two panels are disposed in a stack on top of one another. In the tablet mode, the display panel faces outwardly and may provide touch screen functionality as found in conventional tablets. In the notebook mode, the two panels may be arranged in an open clamshell configuration.

In various embodiments, the accelerometer may be a 3-axis accelerometer having data rates of at least 50 Hz. A gyroscope may also be included, which can be a 3-axis gyroscope. In addition, an e-compass/magnetometer may be present. Also, one or more proximity sensors may be provided (e.g., for lid open to sense when a person is in proximity (or not) to the system and adjust power/performance to extend battery life). For some OS's Sensor Fusion capability including the accelerometer, gyroscope, and compass may provide enhanced features. In addition, via a sensor hub having a real-time clock (RTC), a wake from sensors mechanism may be realized to receive sensor input when a remainder of the system is in a low power state.

In some embodiments, an internal lid/display open switch or sensor to indicate when the lid is closed/open, and can be used to place the system into Connected Standby or automatically wake from Connected Standby state. Other system sensors can include ACPI sensors for internal processor, memory, and skin temperature monitoring to enable changes to processor and system operating states based on sensed parameters.

Also seen in FIG. 8, various peripheral devices may couple to processor 810. In the embodiment shown, various components can be coupled through an embedded controller 835. Such components can include a keyboard 836 (e.g., coupled via a PS2 interface), a fan 837, and a thermal sensor 839. In some embodiments, touch pad 830 may also couple to EC 835 via a PS2 interface. In addition, a security processor such as a trusted platform module (TPM) 838 in accordance with the Trusted Computing Group (TCG) TPM Specification Version 1.2, dated Oct. 2, 2003, may also couple to processor 810 via this LPC interconnect. However, understand the scope of the present disclosure is not limited in this regard and secure processing and storage of secure information may be in another protected location such as a static random access memory (SRAM) in a security coprocessor, or as encrypted data blobs that are only decrypted when protected by a secure enclave (SE) processor mode.

In a particular implementation, peripheral ports may include a high definition media interface (HDMI) connector (which can be of different form factors such as full size, mini or micro); one or more USB ports, such as full-size external ports in accordance with the Universal Serial Bus (USB) Revision 3.2 Specification (September 2017), with at least one powered for charging of USB devices (such as smartphones) when the system is in Connected Standby state and is plugged into AC wall power. In addition, one or more Thunderbolt™ ports can be provided. Other ports may include an externally accessible card reader such as a full size SD-XC card reader and/or a SIM card reader for WWAN (e.g., an 8 pin card reader). For audio, a 3.5 mm jack with stereo sound and microphone capability (e.g., combination functionality) can be present, with support for jack detection (e.g., headphone only support using microphone in the lid or headphone with microphone in cable). In some embodiments, this jack can be re-taskable between stereo headphone and stereo microphone input. Also, a power jack can be provided for coupling to an AC brick.

System 800 can communicate with external devices in a variety of manners, including wirelessly. In the embodiment shown in FIG. 8, various wireless modules, each of which can correspond to a radio configured for a particular wireless communication protocol, are present. One manner for wireless communication in a short range such as a near field may be via a near field communication (NFC) unit 845 which may communicate, in one embodiment with processor 810 via an SMBus. Note that via this NFC unit 845, devices in close proximity to each other can communicate. For example, a user can enable system 800 to communicate with another portable device such as a smartphone of the user via adapting the two devices together in close relation and enabling transfer of information such as identification information payment information, data such as image data or so forth. Wireless power transfer may also be performed using a NFC system.

Using the NFC unit described herein, users can bump devices side-to-side and place devices side-by-side for near field coupling functions (such as near field communication and wireless power transfer (WPT)) by leveraging the coupling between coils of one or more of such devices. More specifically, embodiments provide devices with strategically shaped, and placed, ferrite materials, to provide for better coupling of the coils. Each coil has an inductance associated with it, which can be chosen in conjunction with the resistive, capacitive, and other features of the system to enable a common resonant frequency for the system.

As further seen in FIG. 8, additional wireless units can include other short range wireless engines including a WLAN unit 850 and a Bluetooth unit 852. Using WLAN unit 850, Wi-Fi™ communications in accordance with a given Institute of Electrical and Electronics Engineers (IEEE) 802.11 standard can be realized, while via Bluetooth unit 852, short range communications via a Bluetooth protocol can occur. These units may communicate with processor 810 via, e.g., a USB link or a universal asynchronous receiver transmitter (UART) link. Or these units may couple to processor 810 via an interconnect according to a Peripheral Component Interconnect Express™ (PCIe™) protocol, e.g., in accordance with the PCI Express™ Specification Base Specification version 3.0 (published Jan. 17, 2007), or another such protocol such as a serial data input/output (SDIO) standard. Of course, the actual physical connection between these peripheral devices, which may be configured on one or more add-in cards, can be by way of the NGFF connectors adapted to a motherboard.

In addition, wireless wide area communications, e.g., according to a cellular or other wireless wide area protocol, can occur via a WWAN unit 856 which in turn may couple to a subscriber identity module (SIM) 857. In addition, to enable receipt and use of location information, a GPS module 855 may also be present. Note that in the embodiment shown in FIG. 8, WWAN unit 856 and an integrated capture device such as a camera module 854 may communicate via a given USB protocol such as a USB 2.0 or 3.0 link, or a UART or I2C protocol. Again, the actual physical connection of these units can be via adaptation of a NGFF add-in card to an NGFF connector configured on the motherboard.

In a particular embodiment, wireless functionality can be provided modularly, e.g., with a WiFi™ 802.11ac solution (e.g., add-in card that is backward compatible with IEEE 802.11abgn) with support for Windows 8 CS. This card can be configured in an internal slot (e.g., via an NGFF adapter). An additional module may provide for Bluetooth capability (e.g., Bluetooth 4.0 with backwards compatibility) as well as Intel® Wireless Display functionality. In addition NFC support may be provided via a separate device or multi-function device, and can be positioned as an example, in a front right portion of the chassis for easy access. A still additional module may be a WWAN device that can provide support for 3G/4G/LTE and GPS. This module can be implemented in an internal (e.g., NGFF) slot. Integrated antenna support can be provided for WiFi™, Bluetooth, WWAN, NFC and GPS, enabling seamless transition from WiFi™ to WWAN radios, wireless gigabit (WiGig) in accordance with the Wireless Gigabit Specification (July 2010), and vice versa.

As described above, an integrated camera can be incorporated in the lid. As one example, this camera can be a high resolution camera, e.g., having a resolution of at least 2.0 megapixels (MP) and extending to 6.0 MP and beyond.

To provide for audio inputs and outputs, an audio processor can be implemented via a digital signal processor (DSP) 860, which may couple to processor 810 via a high definition audio (HDA) link. Similarly, DSP 860 may communicate with an integrated coder/decoder (CODEC) and amplifier 862 that in turn may couple to output speakers 863 which may be implemented within the chassis. Similarly, amplifier and CODEC 862 can be coupled to receive audio inputs from a microphone 865 which in an embodiment can be implemented via dual array microphones (such as a digital microphone array) to provide for high quality audio inputs to enable voice-activated control of various operations within the system. Note also that audio outputs can be provided from amplifier/CODEC 862 to a headphone jack 864. Although shown with these particular components in the embodiment of FIG. 8, understand the scope of the present disclosure is not limited in this regard.

In a particular embodiment, the digital audio codec and amplifier are capable of driving the stereo headphone jack, stereo microphone jack, an internal microphone array and stereo speakers. In different implementations, the codec can be integrated into an audio DSP or coupled via an HD audio path to a peripheral controller hub (PCH). In some implementations, in addition to integrated stereo speakers, one or more bass speakers can be provided, and the speaker solution can support DTS audio.

In some embodiments, processor 810 may be powered by an external voltage regulator (VR) and multiple internal voltage regulators that are integrated inside the processor die, referred to as fully integrated voltage regulators (FIVRs). The use of multiple FIVRs in the processor enables the grouping of components into separate power planes, such that power is regulated and supplied by the FIVR to only those components in the group. During power management, a given power plane of one FIVR may be powered down or off when the processor is placed into a certain low power state, while another power plane of another FIVR remains active, or fully powered.

Power control in the processor can lead to enhanced power savings. For example, power can be dynamically allocated between cores, individual cores can change frequency/voltage, and multiple deep low power states can be provided to enable very low power consumption. In addition, dynamic control of the cores or independent core portions can provide for reduced power consumption by powering off components when they are not being used.

In different implementations, a security module such as a TPM can be integrated into a processor or can be a discrete device such as a TPM 2.0 device. With an integrated security module, also referred to as Platform Trust Technology (PTT), BIOS/firmware can be enabled to expose certain hardware features for certain security features, including secure instructions, secure boot, Intel® Anti-Theft Technology, Intel® Identity Protection Technology, Intel® Trusted Execution Technology (TxT), and Intel® Manageability Engine Technology along with secure user interfaces such as a secure keyboard and display.

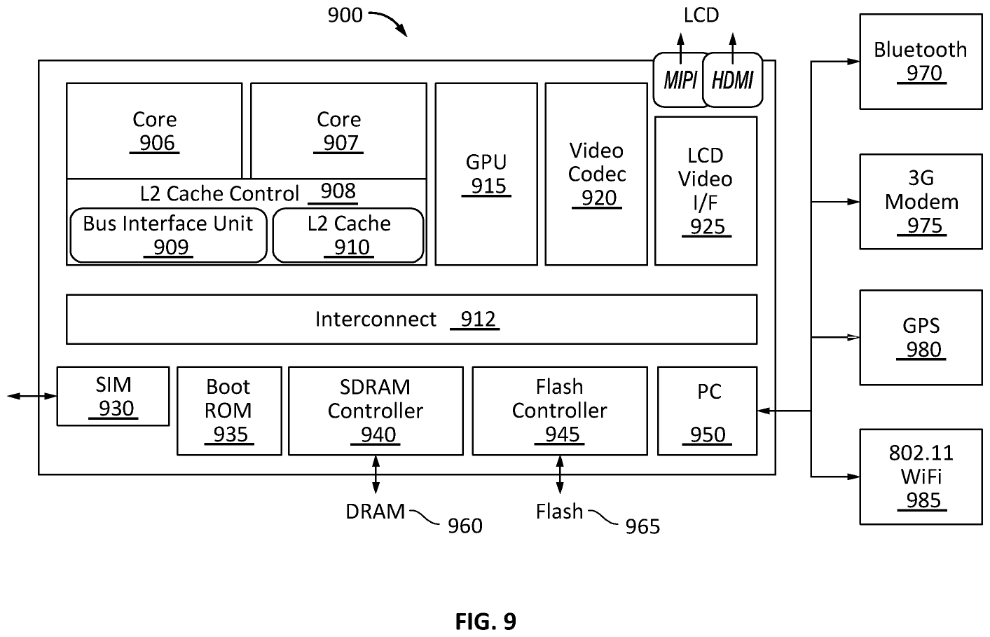

Turning next to FIG. 9, another block diagram for an example computing system that may serve as a host device or peripheral device (or may include both a host device and one or more peripheral devices) in accordance with certain embodiments is shown. As a specific illustrative example, SoC 900 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SoC 900 includes 2 cores-906 and 907. Similar to the discussion above, cores 906 and 907 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 906 and 907 are coupled to cache control 908 that is associated with bus interface unit 909 and L2 cache 910 to communicate with other parts of system 900. Interconnect 912 includes an on-chip interconnect, such as an IOSF, AMBA, or other interconnect discussed above, which potentially implements one or more aspects of the described disclosure.

Interconnect 912 provides communication channels to the other components, such as a Subscriber Identity Module (SIM) 930 to interface with a SIM card, a boot rom 935 to hold boot code for execution by cores 906 and 907 to initialize and boot SoC 900, a SDRAM controller 940 to interface with external memory (e.g. DRAM 960), a flash controller 945 to interface with non-volatile memory (e.g. Flash 965), a peripheral control 950 (e.g. Serial Peripheral Interface) to interface with peripherals, video codecs 920 and Video interface 925 to display and receive input (e.g. touch enabled input), GPU 915 to perform graphics related computations, etc. Any of these interfaces may incorporate aspects of the disclosure described herein.

In addition, the system illustrates peripherals for communication, such as a Bluetooth module 970, 3G modem 975, GPS 980, and WiFi 985. Note as stated above, a UE includes a radio for communication. As a result, these peripheral communication modules are not all required. However, in a UE some form of a radio for external communication is to be included.

Although the drawings depict particular computer systems, the concepts of various embodiments are applicable to any suitable integrated circuits and other logic devices. Examples of devices in which teachings of the present disclosure may be used include desktop computer systems, server computer systems, storage systems, handheld devices, tablets, other thin notebooks, systems on a chip (SOC) devices, and embedded applications. Some examples of handheld devices include cellular phones, digital cameras, media players, personal digital assistants (PDAs), and handheld PCs. Embedded applications may include, e.g., a microcontroller, a digital signal processor (DSP), an SOC, a network computer (NetPC), a set-top box, a network hub, a wide area network (WAN) switch, or any other system that can perform the functions and operations taught below. Various embodiments of the present disclosure may be used in any suitable computing environment, such as a personal computing device, a server, a mainframe, a cloud computing service provider infrastructure, a datacenter, a communications service provider infrastructure (e.g., one or more portions of an Evolved Packet Core), or other environment comprising a group of computing devices.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

A module as used herein or as depicted in the FIGs. refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Logic may be used to implement any of the flows described or functionality of the various components of the FIGs., subcomponents thereof, or other entity or component described herein. “Logic” may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a storage device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in storage devices.

Use of the phrase ‘to’ or ‘configured to,’ in one embodiment, refers to arranging, putting together, manufacturing, offering to sell, importing, and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash storage devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Example 1 includes a system comprising a discrete graphics system-on-chip (SoC) to couple to a host processor unit, the SoC comprising a memory bridge comprising a first port to receive requests sent by a compute engine through a first path to the memory; and a second port to receive requests sent by a plurality of agents of the SoC through a second path to the memory.

Example 2 includes the subject matter of Example 1, and wherein during a low power state of the SoC, the first path to the memory is not active and the second path to the memory is active.

Example 3 includes the subject matter of any of Examples 1 and 2, and wherein during the low power state of the SoC, the second path to the memory is to transport data associated with debugging operations.

Example 4 includes the subject matter of any of Examples 1-3, and wherein the first path to the memory has a higher maximum bandwidth than the second path to the memory.

Example 5 includes the subject matter of any of Examples 1-4, and further including a memory port, the memory port to queue requests from the plurality of agents of the SoC.

Example 6 includes the subject matter of any of Examples 1-5, and wherein the memory port is further to translate requests from the plurality of agents of the SoC into a protocol used by the memory bridge.

Example 7 includes the subject matter of any of Examples 1-6, and further including an interconnect fabric in the first path to the memory, the interconnect fabric comprising a routing table specifying forwarding of traffic from the SoC agents to the memory port.

Example 8 includes the subject matter of any of Examples 1-7, and wherein the memory bridge comprises arbitration logic to arbitrate between requests received through the first path to the memory and requests received through the second path to the memory.

Example 9 includes the subject matter of any of Examples 1-8, and wherein the memory bridge comprises a third port to receive requests sent by an isochronous agent through a third path to the memory.

Example 10 includes the subject matter of any of Examples 1-9, and wherein the memory bridge further comprises arbitration logic to give priority to requests sent by the isochronous agent over requests sent by the agents of the SoC.

Example 11 includes the subject matter of any of Examples 1-10, and further including the compute engine.

Example 12 includes the subject matter of any of Examples 1-11, and further including the memory.

Example 13 includes the subject matter of any of Examples 1-12, and further including the host processor unit.

Example 14 includes the subject matter of any of Examples 1-13, further comprising a battery communicatively coupled to the host processor unit, a display communicatively coupled to the host processor unit, or a network interface communicatively coupled to the host processor unit.

Example 15 includes an apparatus comprising a plurality of memory controllers to couple to a plurality of memory devices of a discrete graphics system; a memory bridge coupled to the plurality of memory controllers, the memory bridge comprising a first port to receive requests sent by a compute engine through a first path to the memory; and a second port to receive requests sent by a plurality of agents of the discrete graphics system through a second path to the memory.

Example 16 includes the subject matter of Example 15, and further including a plurality of bridge endpoints, wherein each bridge endpoint is coupled to a respective memory controller of the plurality of memory controllers.

Example 17 includes the subject matter of any of Examples 15 and 16, and wherein the memory bridge comprises a router to route an incoming request received on the first port or second port to a bridge endpoint of the plurality of bridge endpoints based on a hash of an address of the incoming request.

Example 18 includes the subject matter of any of Examples 15-17, and wherein responsive to a command to enter a low power state, the first path to the memory is deactivated, wherein during the low power state the second path to the memory is active.

Example 19 includes the subject matter of any of Examples 15-18, and wherein during the low power state of the SoC, the second path to the memory is to transport data associated with debugging operations.

Example 20 includes the subject matter of any of Examples 15-19, and wherein the first path to the memory has a higher maximum bandwidth than the second path to the memory.

Example 21 includes the subject matter of any of Examples 15-20, and further including a memory port, the memory port to queue requests from the plurality of agents of the SoC.

Example 22 includes the subject matter of any of Examples 15-21, and wherein the memory port is further to translate requests from the plurality of agents of the SoC into a protocol used by the memory bridge.

Example 23 includes the subject matter of any of Examples 15-22, and further including an interconnect fabric in the first path to the memory, the interconnect fabric comprising a routing table specifying forwarding of traffic from the SoC agents to the memory port.

Example 24 includes the subject matter of any of Examples 15-23, and wherein the memory bridge comprises arbitration logic to arbitrate between requests received through the first path to the memory and requests received through the second path to the memory.

Example 25 includes the subject matter of any of Examples 15-24, and wherein the memory bridge comprises a third port to receive requests sent by an isochronous agent through a third path to the memory.

Example 26 includes the subject matter of any of Examples 15-25, and wherein the memory bridge further comprises arbitration logic to give priority to requests sent by the isochronous agent over requests sent by the agents of the SoC.

Example 27 includes the subject matter of any of Examples 15-26, and further including the compute engine.

Example 28includes the subject matter of any of Examples 15-27, and further including the memory.

Example 29 includes the subject matter of any of Examples 15-28, and further including the host processor unit.

Example 30 includes the subject matter of any of Examples 15-29, further comprising a battery communicatively coupled to the host processor unit, a display communicatively coupled to the host processor unit, or a network interface communicatively coupled to the host processor unit.

Example 31 includes a method comprising forming a discrete graphics system-on-chip (SoC) to couple to a host processor unit, the SoC comprising a memory bridge comprising a first port to receive requests sent by a compute engine through a first path to the memory; and a second port to receive requests sent by a plurality of agents of the SoC through a second path to the memory.

Example 32 includes the subject matter of Example 31, and further including coupling the SoC to the memory.

Example 33 includes the subject matter of any of Examples 31 and 32, and wherein during a low power state of the SoC, the first path to the memory is not active and the second path to the memory is active.

Example 34 includes the subject matter of any of Examples 31-33, and wherein during the low power state of the SoC, the second path to the memory is to transport data associated with debugging operations.

Example 35 includes the subject matter of any of Examples 31-34, and wherein the first path to the memory has a higher maximum bandwidth than the second path to the memory.

Example 36 includes the subject matter of any of Examples 31-35, the SoC further comprising a memory port, the memory port to queue requests from the plurality of agents of the SoC.

Example 37 includes the subject matter of any of Examples 31-36, the memory port further to translate requests from the plurality of agents of the SoC into a protocol used by the memory bridge.

Example 38 includes the subject matter of any of Examples 31-36, the SoC further comprising an interconnect fabric on the first path to the memory, the interconnect fabric comprising a routing table specifying forwarding of traffic from the SoC agents to the memory port.

Example 39 includes the subject matter of any of Examples 31-38, the memory bridge comprising arbitration logic to arbitrate between requests received through the first path to the memory and requests received through the second path to the memory.

Example 40 includes the subject matter of any of Examples 31-39, the memory bridge comprising a third port to receive requests sent by an isochronous agent through a third path to the memory.

Example 41 includes the subject matter of any of Examples 31-40, the memory bridge further comprising arbitration logic to give priority to requests sent by the isochronous agent over requests sent by the agents of the SoC.

Example 42 includes the subject matter of any of Examples 31-41, and further including forming the compute engine.

Example 43 includes the subject matter of any of Examples 31-42 , and further including coupling the SoC to the host processor unit.

Example 44 includes the subject matter of any of Examples 31-43, and further including communicatively coupling a batter, a display, or a network interface to the host processor unit.

What is claimed is:

1. A system comprising:
a discrete graphics system-on-chip (SoC) to couple to a host processor unit, the SoC comprising:
a memory bridge comprising:
a first port to receive requests sent by a compute engine through a first path to the memory; and
a second port to receive requests sent by a plurality of agents of the SoC through a second path to the memory.

2. The system of claim 1, wherein during a low power state of the SoC, the first path to the memory is not active and the second path to the memory is active.

3. The system of claim 2, wherein during the low power state of the SoC, the second path to the memory is to transport data associated with debugging operations.

4. The system of claim 1, wherein the first path to the memory has a higher maximum bandwidth than the second path to the memory.

5. The system of claim 1, further comprising a memory port, the memory port to queue requests from the plurality of agents of the SoC.

6. The system of claim 5, the memory port further to translate requests from the plurality of agents of the SoC into a protocol used by the memory bridge.

7. The system of claim 5, further comprising an interconnect fabric in the first path to the memory, the interconnect fabric comprising a routing table specifying forwarding of traffic from the SoC agents to the memory port.

8. The system of claim 1, the memory bridge comprising arbitration logic to arbitrate between requests received through the first path to the memory and requests received through the second path to the memory.

9. The system of claim 1, the memory bridge comprising a third port to receive requests sent by an isochronous agent through a third path to the memory.

10. The system of claim 9, the memory bridge further comprising arbitration logic to give priority to requests sent by the isochronous agent over requests sent by the agents of the SoC.

11. The system of claim 1, further comprising the compute engine.

12. The system of claim 1, further comprising the memory.

13. The system of claim 1, further comprising the host processor unit.

14. The system of claim 12, further comprising a battery communicatively coupled to the host processor unit, a display communicatively coupled to the host processor unit, or a network interface communicatively coupled to the host processor unit.

15. An apparatus comprising:
a plurality of memory controllers to couple to a plurality of memory devices of a discrete graphics system;
a memory bridge coupled to the plurality of memory controllers, the memory bridge comprising:
a first port to receive requests sent by a compute engine through a first path to the memory; and
a second port to receive requests sent by a plurality of agents of the discrete graphics system through a second path to the memory.

16. The apparatus of claim 15, the apparatus further comprising a plurality of bridge endpoints, wherein each bridge endpoint is coupled to a respective memory controller of the plurality of memory controllers.

17. The apparatus of claim 16, the memory bridge comprising a router to route an incoming request received on the first port or second port to a bridge endpoint of the plurality of bridge endpoints based on a hash of an address of the incoming request.

18. The apparatus of claim 15, wherein responsive to a command to enter a low power state, the first path to the memory is deactivated, wherein during the low power state the second path to the memory is active.

19. A method comprising:
forming a discrete graphics system-on-chip (SoC) to couple to a host processor unit, the SoC comprising:
a memory bridge comprising:
a first port to receive requests sent by a compute engine through a first path to the memory; and
a second port to receive requests sent by a plurality of agents of the SoC through a second path to the memory.

20. The method of claim 19, further comprising coupling the SoC to the memory.
